(19) United States
(12) Patent Application Publication
(10) Pub. No.: US 2011/0241339 A1
(43) Pub. Date: Oct. 6, 2011

(54) SEALED TUBULAR CONNECTION USED IN THE OIL INDUSTRY, AND METHOD FOR PRODUCING SAID CONNECTION

(75) Inventors: Eric Verger, Gommegnies (FR); Bertrand Maillon, Saint Etienne (FR); Daly Daly, Valenciennes (FR); Sylvain Beigneux, Valenciennes (FR)

(73) Assignees: VALLOUREC MANNESMANN OOIL & GAS FRANCE, Aulnoye-Aymeries (FR); SUMITOMO METAL INDUSTRIES, LTD., Osaka-shi (JP)

(21) Appl. No.: 13/139,188

(22) PCT Filed: Dec. 1, 2009
(86) PCT No.: PCT/EP2009/008550

§ 371 Date: Jun. 10, 2011

(30) Foreign Application Priority Data
Dec. 10, 2008 (FR) 0806950

(51) Int. Cl. E21B 17/042; F16L 15/04; B23P 11/00

(52) U.S. Cl. 285/332.2; 29/428

(57) ABSTRACT

A threaded connection and a method for producing such a connection. The threaded connection includes a first and a second tubular component. The first component includes a male end provided on its outer peripheral surface with, in succession, a threaded zone, a sealing surface, and a terminal surface finishing in an abutment surface orientated radially with respect to the axis of revolution of the connection. The second component includes a female end provided on its inner peripheral surface with, in succession, a threaded zone, a sealing surface, and a recess finishing in an abutment surface orientated radially with respect to the axis of revolution of the connection. The threaded zone of the male end is made up into the threaded zone of the female end such that the sealing surfaces are in interfering contact, as are the abutment surfaces, the space between the terminal surface and the recess defining a volume at least partially filled with a filling material.

The invention relates to the field of sealed connections for tubular components used in particular for drilling or for operating hydrocarbon wells. In such applications, the connections have to have an excellent tightness during their use since they are subjected to large compressive and tensile loads.

The American Petroleum Institute (API) defines, in specifications 5CT and 5B, standard connections which in particular comprise coupling the threaded zones of two connected components; the tightness results from applying grease inserted between the male and female threaded zones and as a consequence the tightness performances are limited to liquids or gases moving at a fairly low pressure.

In order to strengthen the tightness, the prior art describes premium connections, developed in particular by the Applicant, which exceed the API standards and which have “sealing” surfaces close to the threaded zones, said surfaces being brought into interference contact as the components are made up.

It is also known for the threaded zones to be provided at the end of each of the male and female tubular components. It should be noted that the female tubular component may be a great length tube or, in contrast, a short coupling type tube. The fluid tightness (to liquids or gas) under high pressure thus results from mutual contact of the sealing surfaces subsequent to radial interference occurring. The intensity of the radial tightening is a function of the relative axial position of the male and female threaded zones, said relative positioning being determined, for example, by bringing the surfaces of abutments provided in the male and female ends respectively into contact, or by using self-locking threads.

In the case in which the relative positioning results from bringing abutments into contact, in the prior art it is also known to provide the abutment surfaces on the inner side of the connection. More precisely, the outer periphery of the male end comprises a threaded zone prolonged by a sealing surface which is itself prolonged by a terminal portion finishing in an abutment surface which is radially orientated with respect to the axis of revolution of the connection. Similarly, the inner periphery of the female end comprises a recess (also termed a concave surface) defined on the one hand by an annular surface which is radially orientated with respect to the axis of the connection and by a sealing surface. The female sealing surface is itself prolonged by a threaded zone. Thus, when the sealing surface of the male end is interference fitted against the sealing surface of the corresponding female end, like with the corresponding abutment surfaces, the outer surface of the terminal portion of the male end (termed the terminal surface) is not in contact with the recess of the female end. To facilitate connection, also termed make-up, between the two tubular components, it is ensured that the terminal portion of the male end is taken into abutment during make-up without rubbing against the recess of the female end. Thus, only the sealing surfaces come into interference contact. For this reason, a space is defined between the outer peripheral surface of the end portion of the male end and the inner peripheral surface of the concave portion of the female end.

As mentioned above, premium connections are subjected to axial tensile or compressive loads, internal or external fluid pressures, and bending or torsional stresses, which may be combined and which may fluctuate in intensity. The tightness must be guaranteed despite the stresses and despite harsh on-site conditions of service. The threaded connections must be capable of being made up and broken out several times without a degradation in their performance, especially by galling. After breakout, the tubular components may be re-used under other conditions of service.

In order to simulate these various stress scenarios, the threaded connections may undergo combined stress cycles in accordance with ISO standard 13679:2002. Such combined stress cycles are included within a performance envelope termed the VME (von Mises ellipse), determined by the yield strength of the material and the geometry of the tubular components. Such cycles thus predict the application of alternating stresses to the threaded connection which combine internal pressure and/or axial tension or axial compression or which combine external pressure and/or axial tension or axial compression. The sealing surfaces of the threaded connections have to remain tight throughout the cycle.

As an example, document WO-2004/109173 describes a threaded connection comprising a male end provided with an axial abutment and intended to be in contact with an axial abutment of the female end and a lip extending between the threaded zone and the axial abutment, said lip comprising a substantially tapered sealing surface close to the threaded zone and thus at a distance from the axial abutment, the terminal portion of the lip between the sealing surface and the axial abutment having an outer surface with a diameter which is very slightly smaller than the corresponding surface of the female end. This type of threaded connection performs well in tests and under real conditions of service.

However, the Applicant has discovered a physical phenomenon which has been ignored until now; pressure is trapped in the small volume defined by the terminal portion of the male end and the corresponding surface of the female end of a threaded connection of the type described in document WO-2004/109173. In the case in which a high axial tensile load is exerted on the threaded connection, the male and female axial abutments may become separated, the sealing surfaces remaining in tight (sealed) contact. The fluid present in the threaded connection may then spread into the small volume. Next, when the tensile load ceases or when the load becomes compressive, the axial abutments again come into mutual contact, trapping the fluid at the pressure prevailing in the connection when the tensile load ceases. In the case in which the internal pressure of the connection then reduces, said small volume remains filled with said fluid at a pressure which is greater than that prevailing inside the connection.

Since the surface of the female end opposite to the lip of the male end is manufactured so as to be more rigid than the lip on the male end, the lip on the male end tends to bend inwardly under the effect of said high pressure trapped in said small volume, although the inner surface of the lip is now only subjected to a low pressure. The inwards radial deformation of the lip of the male end may thus cause a leak, allowing fluid to pass between the sealing surfaces and spread into the threaded zone. In addition to a loss of fluid moving inside the tubes and a drop in the productivity of the well, this may result in contamination of the fluid present outside the tube by a fluid present inside the tube. Moreover, the radial deformation of the lip may cause leaks when the threaded connection is once again subjected to high internal or external fluid pressures.

Further, the radial deformation of the lip may cause a loss of structural integrity under compression and may cause tools which are displaced inside the tubes to become caught.

Such a phenomenon of trapping internal pressure and problems with leaks and other resulting problems were completely unknown in the art since the male sealing surface is generally located at the end of the lip and is adjacent to the abutment in the majority of premium threaded connections.

Further, the Applicant was not immediately aware of problems with the threaded connection of document WO-2004/109173 because the test standard ISO 13679:2002 requires, in paragraph 6-7 thereof, that the threaded connections to be tested be specifically modified in order to test the sealing surfaces. During such tests on threaded connections which are modified for the test, problems which may arise with a commercial ready-to-use threaded connection overall may not be noticed. The Applicant has learned by experience that the standardized tests were not representative of the actual behaviour of such a connection.

The Applicant had to carry out tests on a threaded connection equipped to measure the pressure in the small volume defined by the terminal surface of the male end and the opposed surface of the female end in order to appreciate the trapping phenomenon. The Applicant then sought to remedy this new trapping problem, in particular by improving the overall tightness of the connection.

For this reason, the aim of the invention is to prevent the terminal portion of the male end from deforming, by filling the small volume defined by the terminal surface of the male end and the opposed surface of the female end such that there can no longer be a pressure differential.

More particularly, the invention provides a threaded connection comprising a first and a second tubular component, the first component comprising a male end provided on its outer peripheral surface with, in succession, a threaded zone, a sealing surface then a terminal surface finishing in an abutment surface which is orientated radially with respect to the axis of revolution of the connection, the second component comprising a female end provided on its inner peripheral surface with, in succession, a threaded zone, a sealing surface then a recess finishing in an abutment surface which is orientated radially with respect to the axis of revolution of the connection, the threaded zone of the male end being made up into the threaded zone of the female end such that the sealing surfaces are in interfering contact, as are the abutment surfaces, the space between the terminal surface and the recess defining a volume, characterized in that the volume is at least partially filled with a filling material.

In accordance with certain characteristics, the volume is completely filled with the filling material.

In accordance with other characteristics, the filling material is constituted by at least one metal material selected from the list defined by soft metals, copper alloys, shape memory alloys, lead-tin alloys, zinc alloys and lead alloys.

In accordance with other characteristics, the filling material is an organic material.

The invention also aims at a method for producing a threaded connection in accordance with the invention, said method comprising a step for making up a male end into a female end, characterized in that it comprises at least one of the following steps:

A method for producing a threaded connection (1) in accordance with any one of claims 1 to 4, said method comprising a step for making up the male end (3) into the female end (2), characterized in that it comprises at least the following steps:
prior to the make-up operation, at least one first body is disposed around the terminal surface of the male end and/or inside the recess of the female end;
then the make-up operation is carried out in a manner such that the first body occupies at least a portion of the space defined between the terminal surface and the recess.

In accordance with certain characteristics, the method for producing a connection comprises a step in which a second body is positioned around the terminal surface of the male end and/or inside the recess of the female end, before carrying out the make-up operation.

In accordance with other characteristics, the body (bodies) undergoes (undergo) an activation step during the make-up operation, the filling material resulting from activation of the bodies.

In accordance with other characteristics, the body (bodies) undergoes (undergo) an activation step after the make-up operation, the filling material resulting from activation of said bodies.

In accordance with other characteristics, the activation step is an activation step employing a source of energy selected from the list defined by thermal, ultrasound, magnetic radiation, oxygen, applied pressure, and moisture.

The present invention will be better understood form the following detailed description of some embodiments given entirely by way of non-limiting example and illustrated in the accompanying drawings in which:

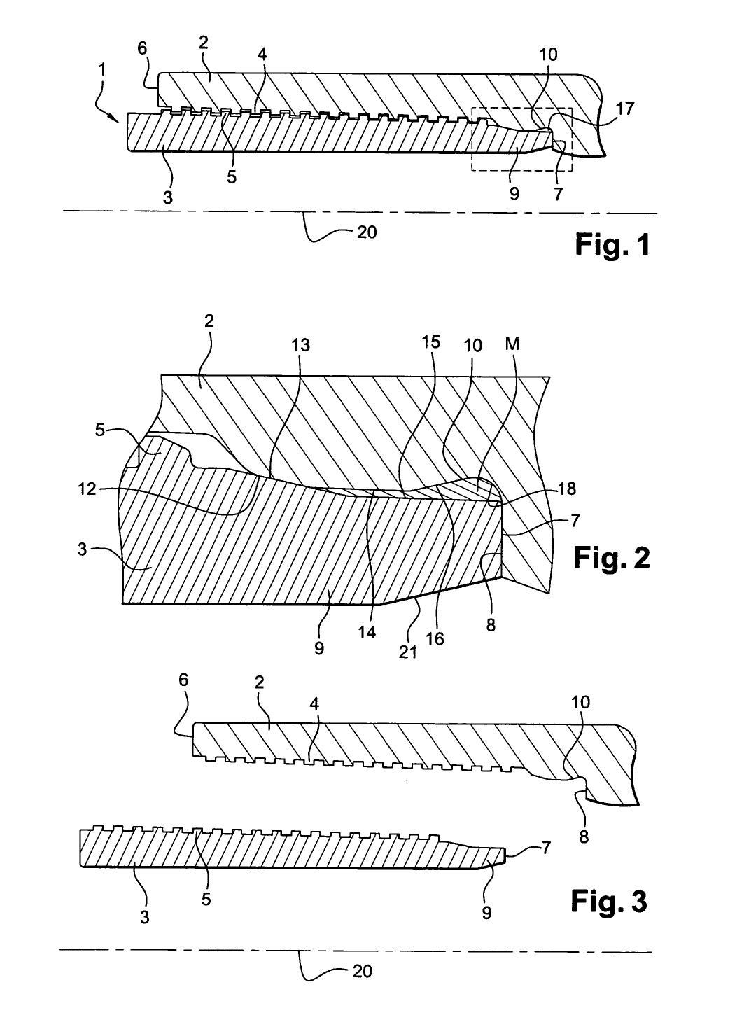

FIG. 1 shows a sectional view of a threaded connection in accordance with one embodiment of the invention;

FIG. 2 shows a detailed view of a threaded connection in accordance with one embodiment of the invention;

FIG. 3 shows a sectional view of a threaded connection which has not been made up, in accordance with one embodiment of the invention.

As can be seen in FIG. 1, a threaded tubular connection 1 comprises a female end 2 and a male end 3. The female end 2 and/or the male end 3 may form part of a tube several metres in length, for example of the order of 10 to 15 metres in length. One end, generally the female end, may constitute the end of a coupling, in other words a short tube which enables to connect together two great length tubes each provided with two male ends (a threaded and coupled connection termed a T&C connection). A coupling can then be provided with two female ends. In a variation, a great length tube may be provided with a male end and a female end (integral threaded connection). The connection 1 is of the commercial mass produced type.

The connection 1 may be used to constitute casing strings or tubing strings for hydrocarbon wells, risers or drillpipe strings for those same wells.

The tubes may be produced from various types of non alloyed, low alloy or high alloy steel, or a ferrous or non ferrous alloy, heat treated or cold-worked depending on the service conditions such as, for example: the degree of mechanical stress, the corrosive nature of the fluid inside or outside the tubes, etc.

It is also possible to use low corrosion resistance steel tubes coated with a protective coating, for example a corrosion resistant alloy or a synthetic material.

The threaded female end 2 comprises a female threaded zone 4 with trapezoidal threads, for example in accordance with API 5B specification (API=American Petroleum Institute) or derived from that specification, for example a thread with a hooked load flank termed a “hooked thread”, such as the thread of the threaded connection sold by the Applicant under the trade name VAM TOP®, for example. The female threaded zone 4 is tapered, for example with a half angle in the range 0.5° to 3°, preferably in the range 1° to 2°. The female threaded zone 4 is disposed on the inside of the female element 2. The male end 3 comprises a male threaded zone 5 disposed on an outer surface of said male end 3. The male threaded zone 5 is engaged with the female threading 4. The female end 2 comprises a distal surface 6 on the side of the threaded zones 4 and 5 which is substantially perpendicular to the axis 20 of the connection. The male threaded zone 5 has a taper which is substantially equal to that of the female threaded zone 4.

The distal surface of the male end 3 is in the form of an annular surface which is orientated radially with respect to the axis 20 of the connection. The distal surface forms an axial abutment surface 7 enabling to limit the relative axial movement between the female end 2 and the male end 3. The abutment surface 7 is in contact against a shoulder of the female end 2 which also forms an abutment surface 8 which is also orientated radially with respect to the axis 20 of the connection. Between the threaded zone 4 and the abutment surface 8, the female end comprises a substantially tapered surface 12 and a recess 10. The recess 10 has a substantially cylindrical surface 14 and a surface of revolution 18 disposed between the substantially tapered surface 12 and the abutment surface 8. The surface of revolution 18 connects the substantially cylindrical surface 14 to the abutment surface 8. The abutment surface 8 may have a tapered shape as described in document EP-0 488 912, or a toroidal shape as in document U.S. Pat. No. 3,870,351 or WO-2007/017082, stepped as in document U.S. Pat. No. 4,611,838, or with a protuberance as in document U.S. Pat. No. 6,047,797, or a combination of these shapes.

The male end 3 comprises a lip 9 extending axially beyond the male threaded zone 5 to an abutment surface 7. The lip 9 comprises an outer substantially tapered surface 13 with an axial length which is slightly greater than the axial length of the substantially tapered surface 12 of the female end 2. A portion of the substantially tapered surface 13 and a portion of the substantially tapered surface 12 are in mutual radial tightening contact in the made up position of the connection 1 illustrated in the figures. These sealing surfaces 12 and 13 enable to prohibit movement of fluid between the interior and exterior of the connection. The cone angle of the sealing surfaces may be in the range 5° to 25°, preferably in the range 10° to 20°, for example 14°. The cone angle of the sealing surfaces is higher than the cone angle of the threaded zones.

The lip 9 of the male end 3 comprises a terminal surface 15 which is substantially cylindrical and extends between the substantially tapered surface 13 and the abutment surface 7 of the male end 3, which may be in the range 4 to 20 mm depending on the diameter of the tube which itself may vary between 50 and 550 mm. It is possible to select, for example, a substantially cylindrical surface length 15 in the range 9 to 16 mm for a tube of 250 mm. The terminal surface 15 has a diameter which is slightly smaller than the diameter of the substantially cylindrical surface 14 of the female end 2. The substantially cylindrical surface 15 connects to the abutment surface 7 via a fillet with a small radius of curvature, for example in the range 0.4 to 1.5 mm, preferably in the range 1 to 1.5 mm. A small volume 17 is thus defined between the outer peripheral surface 15 of the lip 9 and the recess 10. The small volume is generally of a size which is of the order of a few tens of cm³. In the example given, it is close to 25 cm³.

According to the invention, the small volume 17 defined between the terminal surface 15 of the lip 9 and the recess 10 is filled with a filling material M. In our example, the filling material M advantageously fills all of the small volume 17, which means that no fluid coming from inside the connection can be trapped there. Similarly, no fluid coming from outside the connection 1 through the threaded zones 4 and 5 can also be stored there.

In another embodiment, which is not shown in the figures, the filling material M could be disposed so as to only fill a part of the small volume 17 such that all communication between the interior of the connection 1 and the unfilled portion of the small volume 17 is prohibited.

In a first variation of the invention, the filling material M is constituted by at least one metallic material. Advantageously, it is important to use a soft metal such as indium, copper, or gold. It is also possible to use a copper alloy, a lead-tin alloy, a zinc alloy, or a lead alloy. The skilled person would be able to select an alloy composition which is compatible with the thermal and mechanical stresses applied to the connection 1.

It may also be advantageous to use shape memory alloys such as NiTi, CuZnAl, or CuAlNi. Their “super-elastic” behaviour, which is manifested by their ability to remember an initial shape and regain it following deformation, may be advantageous when the connection is broken out then made up again.

In accordance with a second variation of the invention, the filling material M is an organic material of natural and/or synthetic origin. The oligomers and polymers used for this application will preferably be of a thermoplastic nature, such as fluorinated polymers (PTFE, PVDF and derivatives), polyolefins (PE, PP and derivatives), polyamides (PA6, PA6,6 and derivatives), polyoxymethylenes (POM), polyaryletherketones (PEEK, PAEK and derivatives), polyphenylene ether (PPE), polycarbonates (PC); or of a thermosetting nature such as epoxides, polyimides, polyesters, cyanoacrylates, or natural and synthetic elastomers. These materials may be filled, reinforced or supplemented in order to improve their performances or to provide specific properties. These compounds may be organic in nature, such as carbon black, graphite, or polymers; or of mineral origin such as talc, mica, glass or calcium carbonate.

Positioning the filling material M of the invention is carried out in a manner which is closely associated with the operation of making up the male end 3 in the female end 2.

In a first variation of the connection of the invention, before the make-up operation, a first body C′ is placed around the terminal surface 15 of the male end 3. Next, the make-up operation is carried out such that the first body C′ occupies at least a portion of the space defined between the terminal surface 15 of the male end 3 and the recess 10.

Advantageously, the body C′ occupies all of the space defined between the terminal surface 15 of the male end 3 and the recess 10, thereby constituting the filling material M. As an example, it may be possible to use for the body C′ a ring formed from a malleable alloy with an internal diameter such that it can be mounted on the lip 9. Using a shape memory alloy has the advantage that when the connection is broken out, the ring, which has been crushed to match the shape of the small volume 17, regains its initial shape and upon a second make-up operation can again occupy the whole of the volume 17.

In accordance with a second variation of the method, a first body C′ is positioned inside a recess 10 on the female end 4 and then the make-up operation is carried out so that the first body C′ occupies at least a portion of the space defined between the terminal 15 of the male end 3 and the recess 10, thereby constituting the filling material M. As an example, it is possible to use for the body C a ring formed from elastomer with an external diameter such that it can be mounted against the recess 10.

In accordance with another variation of the method, a first body C′ is placed inside the recess 10 of the female end then a second body C″ is positioned around the terminal surface 15 of the lip 9 of the male end 3. Next, the make-up operation between the male and female ends is carried out. The first and second body C′ and C″ react with each other, and so a filling material M is obtained which occupies the whole of the space defined between the terminal surface 15 of the lip 9 and the recess 10.

As an example, the filling material M may be an epoxy which results from cross linking a DGEBA or DGEBD type di-epoxide in the fluid form with a catalyst, for example from the amine family, of the DA12 or DDS type, also in the fluid form.

In this precise case, a layer C′ of DGEBA or DGEBD type di-epoxide fluid may be deposited on the terminal surface 15 and a layer C″ of DA12 or DDS type amine is deposited in the recess 10. Cross-linking is carried out during make-up to produce the epoxy. The skilled person will be able to adjust the proportions so that the epoxy advantageously fills the whole of the volume 17. Of course, C′ or C″ can be supplemented with a tertiary amine or boron trifluoride type accelerator. The layer C′ or C″ may also be filled, for example with talc and/or silica, in order to reduce shrinkage after cross-linking and to increase the mechanical strength.

In accordance with other possible variations of the method, the body or bodies C′, C″ undergoes or undergo an activation step using a source of energy during the make-up operation or even after make-up in order to accelerate the cross-linking process. Thus, the filling material M is obtained which occupies all or part of the space defined between the terminal surface 15 of the lip 9 and the recess 10. The activation step may, for example, use a source of thermal energy or ultrasound or magnetic radiation, oxygen, applied pressure or moisture.

1-9. (canceled)

10: A threaded connection comprising:
a first and a second tubular component,
the first component comprising a male end including on its outer peripheral surface, in succession, a threaded zone, a sealing surface, and then a terminal surface finishing in an abutment surface that is orientated radially with respect to the axis of revolution of the connection,
the second component comprising a female end including on its inner peripheral surface, in succession, a threaded zone, a sealing surface, and then a recess finishing in an abutment surface that is orientated radially with respect to the axis of revolution of the connection,
the threaded zone of the male end being made up into the threaded zone of the female end such that the sealing surfaces are in interfering contact, as are the abutment surfaces,
a space between the terminal surface and the recess defining a volume, wherein the volume is at least partially filled with a filling material.

11: A threaded connection according to claim 10, wherein the volume is completely filled with the filling material.

12: A threaded connection according to claim 10, wherein the filling material is constituted by at least one metal material selected from the list defined by soft metals, copper alloys, shape memory alloys, lead-tin alloys, zinc alloys, and lead alloys.

13: A threaded connection according to claim 10, wherein the filling material is an organic material.

14: A method for producing a threaded connection in accordance with claim 10, the method comprising:
making-up the male end into the female end;
prior to the making-up, disposing at least one first body around the terminal surface of the male end and/or inside the recess of the female end;
then the making-up is carried out such that the first body occupies at least a portion of the space defined between the terminal surface and the recess.

15: A method for producing a connection according to claim 14, further comprising:
prior to the making-up, disposing at least one first body around the terminal surface of the male end and/or inside the recess of the female end;
then positioning a second body around the terminal surface of the male end and/or inside the recess of the female end;
then the making-up is carried out such that the first and second bodies occupy at least a portion of the space defined between the terminal surface and the recess.

16: A method for producing a connection according to claim 14, wherein the body or bodies undergoes (undergo) an activation during the making-up, the filling material resulting from activation of the bodies.

17: A method for producing a connection according to claim 14, wherein the body or bodies undergoes (undergo) an activation after the making-up, the filling material resulting from activation of the bodies.

18: A method for producing a connection according to claim 16, wherein the activation uses a source of energy selected from the list defined by heat, ultrasound, magnetic radiation, oxygen, applied pressure and moisture.
